(19) United States
(12) Patent Application Publication
(10) Pub. No.: US 2026/0254170 A1
(43) Pub. Date: Aug. 27, 2026

(54) MALE CONNECTOR, FEMALE CONNECTOR, AND CONNECTOR COMBINATION

(71) Applicant: Sichuan Huafeng Technology Co., Ltd., Mianyang, Sichuan (CN)

(72) Inventors: Hong HE, Mianyang, Sichuan (CN); Peng ZHAO, Shenzhen, Guangdong (CN); Min LIU, Mianyang, Sichuan (CN)

(73) Assignee: Sichuan Huafeng Technology Co., Ltd., Mianyang, Sichuan (CN)

(21) Appl. No.: 18/877,997

(22) PCT Filed: Dec. 29, 2022
(86) PCT No.: PCT/CN2022/143656

§ 371 Date: Dec. 20, 2024

(30) Foreign Application Priority Data
Jun. 21, 2022 (CN) 202210704291.7
Jun. 21, 2022 (CN) 202210704502.7

(51) Int. Cl. H01R 13/6581; H01R 13/405; H01R 13/502; H01R 13/6471

(52) U.S. Cl. CPC H01R 13/6581; H01R 13/405; H01R 13/502; H01R 13/6471

(57) ABSTRACT

The present application provides a male connector, a female connector, and a connector combination. The male connector comprises a male base, a male conductive surrounding frame, and shielding reinforcement pieces, the female connector comprises a female base, ground terminal mounting slots, and electrical connection pieces, the connector combination comprises the male connector and the female connector, a male connection surface of the male bottom plate and a female connection surface of the female bottom plate are connected face to face, each of the shielding reinforcement pieces is separately inserted into one of the ground terminal mounting slots; each ground terminal mounting slot is provided with an electrical connection piece, each electrical connection piece comprises a protruding structure, the protruding structure is connected to the corresponding shielding reinforcement piece. The connector combination in the present application reduces signal crosstalk and improves the signal shielding effect.

### CROSS-REFERENCE TO RELATED APPLICATIONS

This application claims the benefit of Chinese Patent Application No. 202210704502.7 filed on Jun. 21, 2022 and entitled “MALE CONNECTOR, FEMALE CONNECTOR, AND CONNECTOR COMBINATION”, and benefit of Chinese Patent Application No. 202210704291.7 filed on Jun. 21, 2022 and entitled “MALE CONNECTOR, FEMALE CONNECTOR, AND CONNECTOR COMBINATION”, the disclosures of which are incorporated by reference herein in their entirety.

### TECHNICAL FIELD

The present application relates to the technical field of high-speed connectors, and in particular, relates to a male connector, a female connector and a connector combination.

### BACKGROUND

With the rapid development of the existing communication technology, the transmission rate is continuously improved, and the requirements for the transmission rate and related performance of the connector are increasingly high. In the prior art, signals and shielding of adjacent modules in the high-speed region of the connector are arranged in a staggered manner, so as to achieve the purpose of improving the performance of the product, but applicants have found that the ground contact adjacent to the outermost signal of the CPCI type high-speed connector has only one shielding, resulting in a relatively poor performance of the integrity of the signal located at the outermost side with respect to the integrity of the signal located at the inside.

### BRIEF SUMMARY OF THE INVENTION

According to various embodiments, it is provided with a male connector, a female connector and a connector combination that have a better shielding effect and have a grounding return effect.

According to various embodiments, this application provides the following technical solutions:

A male connector, configured to be connected with a female connector, and the male connector comprises:
a male base, the male base is U-shaped from a side view, and the male base comprises a male bottom plate, a male first side plate and a male second side plate, the male bottom plate is provided with a male connection surface connected with the female connector, the male first side plate and the male second side plate are disposed at the two opposite sides of the male bottom plate in a male first direction respectively, and fixedly connected with the male bottom plate to surround the male connection surface, the male first direction is disposed at the plane where the male connection surface is disposed; a partial region of the male bottom plate is hollowed out, one or more male signal modules are disposed in the partial region, and the male signal module extends from the male connection surface in a direction facing away from the male bottom plate;
a male conductive surrounding frame, configured to be embedded in a hollowed-out region of the male bottom plate and substantially coplanar with the male bottom plate, one or more male grounding modules are disposed on the male conductive surrounding frame, the one or more male grounding modules extend from the male connection surface in a direction facing away from the male bottom plate, the male grounding module and the male signal module are arranged in a staggered manner one by one and shaped as a grid, and the male signal module is electrically connected with the male conductive surrounding frame and then connected to the ground;
one or more shielding reinforcement parts, configured to be disposed at a connection between the male bottom plate and the male first side plate and/or at a connection between the male bottom plate and the male second side plate, the shielding reinforcement part extends from the male connection surface in a direction facing away from the male bottom plate and is electrically connected with the male conductive surrounding frame.

In some embodiments of the present application, any one of the shielding reinforcement parts is disposed near one of the male signal modules, and the shielding reinforcement part is disposed between the corresponding male signal module and the male first side plate and/or between the corresponding male signal module and the male second side plate in the male first direction;
the region of the male bottom plate where the shielding reinforcement piece is disposed is configured as a part of the male conductive surrounding frame.

In some embodiments of the present application, at least one of the male signal modules is a differential signal module;
any one of the shielding reinforcement parts comprises one or more contact terminals, the contact terminals are arranged in a male second direction, and the male second direction is perpendicular to the male first direction on the plane where the male connection surface is disposed;
a root end of each of the contact terminals is fixed to the male bottom plate, a free end of each of the contact terminals extends from the male connection surface in a direction facing away from the male bottom plate, and the contact terminal is configured to be bent or not bent according to a use environment, and the contact terminal is elastic in case where the contact terminal is bent;
in case where each of the shielding reinforcement pieces is provided with one or more contact terminals, the root ends of the contact terminals are configured to be connected or unconnected.

In some embodiments of the present application, any one of the shielding reinforcement parts comprises one or more metal contact terminals, the metal contact terminals are arranged in a male second direction, and the male second direction is perpendicular to the male first direction on the plane where the male connection surface is disposed.

According to various embodiments, this application further provides the following technical solutions:

A female connector, configured to be connected with a male connector, and the female connector comprises:
a female base, the female base is U-shaped from a side view, and the female base comprises a female bottom plate, a female first side plate and a female second side plate, the female bottom plate is provided with a female connection surface connected with the male connector and a female fixing surface opposite to the female connection surface, the female first side plate and the female second side plate are disposed at the two opposite sides of the female bottom plate in a female first direction respectively, and fixedly connected with the female bottom plate to surround the female connection surface, the female first direction is disposed at the plane where the female connection surface is disposed; the female bottom plate is provided with a plurality of via holes, each of the via holes penetrates through the female connection surface and the female fixing surface of the female bottom plate, the plurality of via holes are arranged in a grid in the female first direction and the female second direction, and the female second direction is perpendicular to the female first direction on the plane where the female fixing surface is disposed;
one or more ground terminal mounting slots are disposed on the female first side plate and/or the female second side plate, the ground terminal mounting slot extends from the female connection surface in a female third direction facing away from the female bottom plate;
the ground terminal mounting slot is provided with an electrical connection piece, the electrical connection piece comprises a protruding structure, a protruding side of the protruding structure faces away from the corresponding female first side plate or the female second side plate.

In some embodiments of the present application, the female connector further comprises:
a female conductive surrounding frame, configured to be disposed between the female first side plate and the female second side plate and fixed to the female fixing surface, the female conductive surrounding frame is provided with a plurality of through slots, the plurality of through slots penetrate through the female conductive surrounding frame in a female third direction, and the female third direction is perpendicular to the plane where the female fixing surface is disposed;
one or more conductive terminal modules, configured to be inserted into one of the through slots, any one of the conductive terminal modules is provided with one or more female signal structures and one or more female grounding structures, any one of the female signal structures or any one of the female grounding structures is corresponded to one of the via holes, all of the female signal structures and the female grounding structures are arranged in a staggered manner one by one on the female connection surface of the female bottom plate, all of the female grounding structures are electrically connected with the female conductive surrounding frame and then connected to the ground;
the ground terminal mounting slot exposes the female conductive surrounding frame disposed at a corresponding position, and the electrical connection piece is provided.

In some embodiments of the present application, the female connector further comprises:
one or more conductive reinforcement parts, configured to be disposed at a connection between the female bottom plate and the female first side plate and/or at a connection between the female bottom plate and the female second side plate, or disposed in the female first side plate and/or the female second side plate;
one or more conductive terminal modules, configured to be inserted into the via hole on the female base, any one of the conductive terminal modules is provided with one or more female signal structures and one or more female grounding structures, any one of the female signal structures or any one of the female grounding structures is corresponded to one of the via holes, all of the female signal structures and the female grounding structures are arranged in a staggered manner one by one on the female connection surface of the female bottom plate;
the conductive reinforcement part is electrically connected to the female grounding structure;
the ground terminal mounting slot exposes the conductive reinforcement part disposed at a corresponding position, and the electrical connection piece is provided.

In some embodiments of the present application, any one of the ground terminal mounting slots is disposed near one of the female signal structures, and is arranged correspondently with the corresponding female signal structure in the female first direction;
the ground terminal mounting slot is provided with one or more channels, in case where there are two or more channels, the channels are arranged in parallel and locally connected, the ground terminal mounting slot is provided with the electrical connection piece.

According to various embodiments, this application further provides the following technical solutions:

A connector combination, the connector combination comprises a male connector and a female connector configured to be connected mutually, the male connector comprises:
a male base, the male base is U-shaped from a side view, and the male base comprises a male bottom plate, a male first side plate and a male second side plate, the male bottom plate is provided with a male connection surface connected with the female connector, the male first side plate and the male second side plate are disposed at the two opposite sides of the male bottom plate in a male first direction respectively, and fixedly connected with the male bottom plate to surround the male connection surface, the male first direction is disposed at the plane where the male connection surface is disposed; a partial region of the male bottom plate is hollowed out, one or more male signal modules are disposed in the partial region, and the male signal module extends from the male connection surface in a direction facing away from the male bottom plate;
a male conductive surrounding frame, configured to be embedded in a hollowed-out region of the male bottom plate and substantially coplanar with the male bottom plate, one or more male grounding modules are disposed on the male conductive surrounding frame, the male grounding module extends from the male connection surface in a direction facing away from the male bottom plate, the male grounding module and the male signal module are arranged in a staggered manner one by one and shaped as a grid, and the male signal module is electrically connected with the male conductive surrounding frame and then connected to the ground;
one or more shielding reinforcement parts, configured to be disposed at a connection between the male bottom plate and the male first side plate and/or at a connection between the male bottom plate and the male second side plate, the shielding reinforcement part extends from the male connection surface in a direction facing away from the male bottom plate and is electrically connected with the male conductive surrounding frame;
the female connector comprises:
a female base, the female base is U-shaped from a side view, and the female base comprises a female bottom plate, a female first side plate and a female second side plate, the female bottom plate is provided with a female connection surface connected with the male connector and a female fixing surface opposite to the female connection surface, the female first side plate and the female second side plate are disposed at the two opposite sides of the female bottom plate in a female first direction respectively, and fixedly connected with the female bottom plate to surround the female connection surface, the female first direction is disposed at the plane where the female connection surface is disposed; the female bottom plate is provided with a plurality of via holes, each of the via holes penetrates through the female connection surface and the female fixing surface of the female bottom plate, the plurality of via holes are arranged in a grid in the female first direction and the female second direction, and the female second direction is perpendicular to the female first direction on the plane where the female fixing surface is disposed;
one or more ground terminal mounting slots are disposed on the female first side plate and/or the female second side plate, the ground terminal mounting slot extends from the female connection surface in a female third direction facing away from the female bottom plate;
the ground terminal mounting slot is provided with an electrical connection piece, the electrical connection piece comprises a protruding structure, a protruding side of the protruding structure faces away from the corresponding female first side plate or the female second side plate.

In some embodiments of the present application, the female connector further comprises:
a conductive surrounding frame, configured to be disposed between the female first side plate and the female second side plate and fixed to the female fixing surface, the female conductive surrounding frame is provided with a plurality of through slots, the plurality of through slots penetrate through the female conductive surrounding frame in a female third direction, and the female third direction is perpendicular to the plane where the female fixing surface is disposed;
one or more conductive terminal modules, configured to be inserted into one of the through slots, any one of the conductive terminal modules is provided with one or more female signal structures and one or more female grounding structures, any one of the female signal structures or any one of the female grounding structures is corresponded to one of the via holes, all of the female signal structures and the female grounding structures are arranged in a staggered manner one by one on the female connection surface of the female bottom plate, all of the female grounding structures are electrically connected with the female conductive surrounding frame and then connected to the ground;
the ground terminal mounting slot exposes the female conductive surrounding frame disposed at a corresponding position, and the electrical connection piece is provided;
the male connection surface of the male bottom plate and the female connection surface of the female bottom plate are connected face to face, each of the shielding reinforcement parts is separately inserted into one of the ground terminal mounting slots, and is connected to the corresponding electrical connection piece and/or the female conductive surrounding frame.

In some embodiments of the present application, the female connector further comprises:
one or more conductive reinforcement parts, configured to be disposed at a connection between the female bottom plate and the female first side plate and/or at a connection between the female bottom plate and the female second side plate, or disposed in the female first side plate and/or the female second side plate;
one or more conductive terminal modules, configured to be inserted into the via hole on the female base, any one of the conductive terminal modules is provided with one or more female signal structures and one or more female grounding structures, any one of the female signal structures or any one of the female grounding structures is corresponded to one of the via holes, all of the female signal structures and the female grounding structures are arranged in a staggered manner one by one on the female connection surface of the female bottom plate;
the conductive reinforcement part is electrically connected to the female grounding structure;
the ground terminal mounting slot exposes the conductive reinforcement part disposed at a corresponding position, and the electrical connection piece is provided;
the male connection surface of the male bottom plate and the female connection surface of the female bottom plate are connected face to face, each of the shielding reinforcement parts is separately inserted into one of the ground terminal mounting slots, and the shielding reinforcement part is connected to the corresponding female electrical connection piece and/or the conductive reinforcement part.

In some embodiments of the present application, any one of the shielding reinforcement parts is disposed near one of the male signal modules, and the shielding reinforcement part is disposed between the corresponding male signal module and the male first side plate or between the corresponding male signal module and the male second side plate in the male first direction;
any one of the ground terminal mounting slots is disposed near one of the female signal structures, and is arranged correspondently with the corresponding female signal structure in the female first direction;
the male first direction is the same as the female first direction;
the male connection surface of the male bottom plate and the female connection surface of the female bottom plate are connected face to face, and an outer side of each of the shielding reinforcement parts separately close to one of the ground terminal mounting slots is electrically connected with the electrical connection piece;
any one of the shielding reinforcement pieces comprises one or more contact terminals, the contact terminals are arranged in a male second direction, and the male second direction is perpendicular to the male first direction on the plane where the male connection surface is disposed; a root end of each of the contact terminals is fixed to the male bottom plate, a free end of each of the contact terminals extends from the male connection surface in a direction facing away from the male bottom plate, and the contact terminal is configured to be bent or not bent according to a use environment, and the contact terminal is elastic under the condition that the contact terminal is bent;
in case where the contact terminal is bent, the free end of the contact terminal comprises a first contact portion and a second contact portion, the first contact portion is electrically connected with the electrical connection piece, and the second contact portion is connected to the female conductive surrounding frame or the conductive reinforcement part;
any one of the shielding reinforcement parts at least comprises one or more metal contact terminals, the metal contact terminals are arranged in a male second direction, and the male second direction is perpendicular to the male first direction on the plane where the male connection surface is disposed; a root end of each of the metal contact terminals is fixed to the male bottom plate, a free end of each of the metal contact terminals extends from the male connection surface in a direction facing away from the male bottom plate;
the metal contact terminal is electrically connected with the electrical connection piece.

According to various embodiments, this application further provides the following technical solutions:

A connector combination, the connector combination comprises a male connector and a female connector configured to be connected mutually, the male connector comprises:
a male base, the male base is U-shaped from a side view, and the male base comprises a male bottom plate, a male first side plate and a male second side plate, the male bottom plate is provided with a male connection surface connected with the female connector, the male first side plate and the male second side plate are disposed at the two opposite sides of the male bottom plate in a male first direction respectively, and fixedly connected with the male bottom plate to surround the male connection surface, the male first direction is disposed at the plane where the male connection surface is disposed; a partial region of the male bottom plate is hollowed out, one or more male signal modules are disposed in the partial region, and the male signal module extends from the male connection surface in a direction facing away from the male bottom plate;
a male conductive surrounding frame, configured to be embedded in a hollowed-out region of the male bottom plate and substantially coplanar with the male bottom plate, one or more male grounding modules are disposed on the male conductive surrounding frame, the male grounding module extends from the male connection surface in a direction facing away from the male bottom plate, the male grounding module and the male signal module are arranged in a staggered manner one by one and shaped as a grid, and the male grounding module is electrically connected with the male conductive surrounding frame and then connected to the ground;
one or more shielding reinforcement parts, configured to be disposed at a connection between the male bottom plate and the male first side plate and/or at a connection between the male bottom plate and the male second side plate, the shielding reinforcement part extends from the male connection surface in a direction facing away from the male bottom plate and is electrically connected with the male conductive surrounding frame;
the female connector comprises:
a female base, the female base is U-shaped from a side view, and the female base comprises a female bottom plate, a female first side plate and a female second side plate, the female bottom plate is provided with a female connection surface connected with the male connector and a female fixing surface opposite to the female connection surface, the female first side plate and the female second side plate are disposed at the two opposite sides of the female bottom plate in a female first direction respectively, and fixedly connected with the female bottom plate to surround the female connection surface, the female first direction is disposed at the plane where the female connection surface is disposed; the female bottom plate is provided with a plurality of via holes, each of the via holes penetrates through the female connection surface and the female fixing surface of the female bottom plate, the plurality of via holes are arranged in a grid in the female first direction and the female second direction, and the female second direction is perpendicular to the female first direction on the plane where the female fixing surface is disposed;
one or more ground terminal mounting slots are disposed on the female first side plate and/or the female second side plate, the ground terminal mounting slot extends from the female connection surface in a female third direction facing away from the female bottom plate, a protruding side of the protruding structure faces away from the corresponding female first side plate or the female second side plate, the protruding structure is connected to the shielding reinforcement part.

In some embodiments of the present application, the female connector further comprises:
a female conductive surrounding frame, configured to be disposed between the female first side plate and the female second side plate and fixed to the female fixing surface, the female conductive surrounding frame is provided with a plurality of through slots, the plurality of through slots penetrate through the female conductive surrounding frame in a female third direction, and the female third direction is perpendicular to the plane where the female fixing surface is disposed;
one or more conductive terminal modules, configured to be inserted into one of the through slots, any one of the conductive terminal modules is provided with one or more female signal structures and one or more female grounding structures, any one of the female signal structures or any one of the female grounding structures is corresponded to one of the via holes, all of the female signal structures and the female grounding structures are arranged in a staggered manner one by one on the female connection surface of the female bottom plate, all of the female grounding structures are electrically connected with the female conductive surrounding frame and then connected to the ground;
the ground terminal mounting slot exposes the female conductive surrounding frame disposed at corresponding position, and the electrical connection piece is provided;
each of the shielding reinforcement part is seperately connected to the corresponding electrical connection piece and/or to the corresponding conductive surrounding frame.

In some embodiments of the present application, the female connector further comprises:
one or more conductive reinforcement parts, configured to be disposed at a connection between the female bottom plate and the female first side plate and/or at a connection between the female bottom plate and the female second side plate, or disposed in the female first side plate and/or the female second side plate;
one or more conductive terminal modules, configured to be inserted into the via hole on the female base, any one of the conductive terminal modules is provided with one or more female signal structures and one or more female grounding structures, any one of the female signal structures or any one of the female grounding structures is corresponded to one of the via holes, all of the female signal structures and the female grounding structures are arranged in a staggered manner one by one on the female connection surface of the female bottom plate;
the conductive reinforcement part is electrically connected to the female grounding structure;
the ground terminal mounting slot exposes the conductive reinforcement part disposed at a corresponding position, and the electrical connection piece is provided;
each of the shielding reinforcement part is separately connected to the corresponding electrical connection piece and/or to the corresponding conductive reinforcement part.

The beneficial effects of the present application are as follows:
1. The present application provides a male connector, a female connector, and a connector combination, the male base of the male connector is provided with a shielding reinforcement part, the female base of the female connector is provided with a ground terminal mounting slot, and the inner female conductive surrounding frame is exposed by the ground terminal mounting slot, in case where the male connector and the female connector are connected mutually, the shielding reinforcement part is electrically connected to the ground terminal mounting slot, and shielding reinforcement part is electrically connected to the female conductive surrounding frame, so that the male signal module disposed at the edge position obtains a better shielding effect and a better grounding backflow effect, thereby the performance of the connector is improved.
2. In the present application, a bending contact elastic piece is configured as the shielding reinforcement part, so that two backflow paths are formed, one backflow path is formed by the bending contact elastic piece and the female conductive surrounding frame in an indirect electrical connection way, the bending contact elastic piece is disposed on the ground terminal mounting slot of the female connector, the other backflow path is formed by the bending contact elastic piece directly connected to the female conductive surrounding frame in a direct electrical connection way, constitutes an encircling structure of the signal transmission contact piece, the antenna effect may occur in case where a pin is configured as the shielding reinforcement part is overcome, signal crosstalk and signal loss are optimized, the shielding effect is improved, and the performance of the connector combination is enhanced.
3. The present application provides a signal transmission module, a good shielding effect to the conductive terminal can be achieved in case where the signal transmission module is applied in the female connector, so that possible signal crosstalk is reduced between adjacent conductive terminals.

### BRIEF DESCRIPTION OF THE DRAWINGS

In order to more clearly illustrate the technical solutions in the embodiments of this application, the accompanying drawings required in the description of the embodiments are briefly described below, and the accompanying drawings in the following description are merely some embodiments of the present application.

FIG. 1 (a) is a schematic structural diagram of a male connector according to a first embodiment of the present application;

FIG. 1 (b) is a schematic structural diagram of a male connector according to a second embodiment of the present application;

FIG. 2 is a schematic structural diagram of a bending reed according to this application;

FIG. 3 is a schematic structural diagram of a female connector according to a third embodiment of the present application;

FIG. 4 is a schematic structural diagram of a female connector according to a fourth embodiment of the present application;

FIG. 5 is a schematic structural diagram of a connector combination according to this application;

FIG. 6 is a top view of a connector combination according to this application;

FIG. 7 (a) is a schematic diagram of an effect comparison between the fifth embodiment of the present application and the existing art;

FIG. 7 (b) is a schematic diagram of an effect comparison between the sixth embodiment of the present application and the existing art;

FIG. 8 (a) is a schematic structural diagram of connection between a bending reed and a bump according to a seventh embodiment of the present application;

FIG. 8 (b) is a schematic structural diagram of connection between a bending reed and a bump according to an eighth embodiment of the present application;

FIG. 9 is a schematic structural diagram of a female connector according to a ninth embodiment of the present application;

FIG. 10 (a) is a schematic structural diagram of the female connector in FIG. 9 at another viewing angle;

FIG. 10 (b) is a schematic structural diagram of a female connector according to a tenth embodiment of the present application;

FIG. 11 is a schematic structural diagram of a shielding plate and a bulge on the shielding plate according to an eleventh embodiment of the present application;

FIG. 12 is a schematic structural diagram of a connector combination according to a twelfth embodiment of the present application;

FIG. 13 is an exploded view of the combination in FIG. 12;

FIG. 14 is a schematic structural diagram of a connector combination according to a thirteenth embodiment of this application.

### DESCRIPTION OF THE DRAWINGS

1—male connector; 2—female connector; 3—Connector Combination; 101—male base; 102—male bottom plate; 103—male first side plate; 104—male second side plate; 105—male connection surface; 106—male first direction; 107—male signal module; 108—male conductive surrounding frame; 109—male grounding module; 110—shielding reinforcement part; 111—contact terminal; 112—male second direction; 114—pin; 201—femal base; 202—female bottom plate; 203—female first side plate; 204—female second side plate; 205—female connection surface; 206—female fixing surface; 207—female first direction; 208—female second direction; 209—female conductive surrounding frame; 210—through slot; 211—female third direction; 212—conductive terminal module; 213—female signal structure; 214—female grounding structure; 215—ground terminal mounting slot; 216—electrical connection piece; 2151—channel; 217—via hole; 218—first contact portion; 219—second contact portion; 42—shield plate; 5—bulge; 6—conductive reinforcement part.

### IMPLEMENTATIONS OF THIS APPLICATION

The following clearly and completely describes the technical solutions in embodiments of this application with reference to the accompanying drawings in embodiments of this application. It is clear that the described embodiments are merely some but not all of embodiments of this application. All other embodiments obtained by a person skilled in the art based on embodiments of this application without creative efforts shall fall within the protection scope of this application.

It should be understood that the specific embodiments described herein are only used to illustrate and explain the present application, and are not intended to limit the present application. In the present application, unless otherwise stated, the used words such as “upper” and “lower” generally refer to the upper and lower of the device in actual use or working state, specifically the directions in the accompanying drawings; and “inner” and “outer” are usually specific to the contour of the device.

Embodiments of this application provide a male connector, a female connector, and a connector combination. It should be noted that the description order of the following embodiments is not limited to the preferred order of the embodiments.

### Embodiment 1

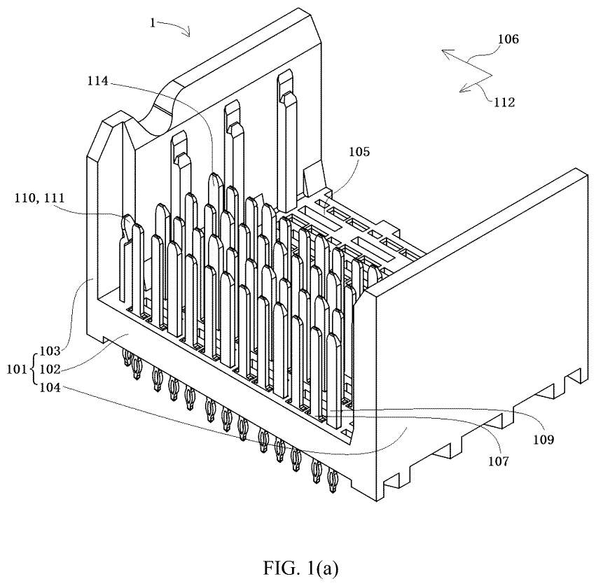

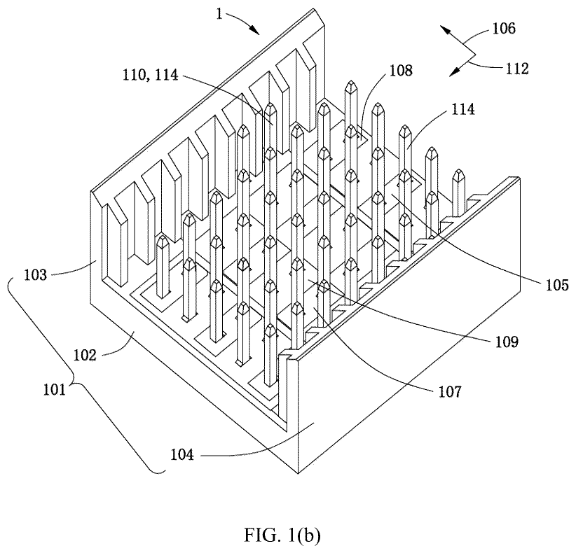

As shown in FIG. 1, in an embodiment of the present application, a male connector 1 is configured to connect with a female connector 2, and the male connector 1 comprises: a male base 101, the male base 101 is U-shaped from a side view, the male base 101 comprises a male bottom plate 102, a male first side plate 103 and a male second side plate 104, the male bottom plate 102 is provided with a male connection surface 105 connected with the female connector 2, the male first side plate 103 and the male second side plate 104 are disposed at the two opposite sides of the male bottom plate 102 in a male first direction 106 respectively, and fixedly connected with the male bottom plate 102 to surround the male connection surface 105, the male first direction 106 is disposed at the plane where the male connection surface 105 is disposed; a partial region of the male bottom plate 102 is hollowed out, one or more male signal modules 107 are disposed in the partial region, and the male signal module 107 extends from the male connection surface 105 in a direction facing away from the male bottom plate 102, and the male signal module 107 is inserted into the female connector 2 in case where the male connector 1 and the female connector 2 is connected with each other.

As shown in FIG. 1, the male connector 1 further comprises: a male conductive surrounding frame 108, the male conductive surrounding frame 108 is configured to be embedded in a hollowed-out region of the male bottom plate 102 and substantially coplanar with the male bottom plate 102, and one or more male grounding modules 109 are disposed on the male conductive surrounding frame 108, the one or more male grounding modules 109 extend from the male connection surface 105 in a direction facing away from the male bottom plate 102, the male grounding module 109 and the male signal module 107 are arranged in a staggered manner one by one and shaped as a grid, and the male grounding module 109 is electrically connected with the male conductive surrounding frame 108 and then connected to the ground.

As shown in FIG. 1, the male connector 1 further comprises one or more shielding reinforcement parts 110, the shielding reinforcement part 110 is disposed at a connection between the male bottom plate 102 and the male first side plate 103 and/or at a connection between the male bottom plate 102 and the male second side plate 104, the shielding reinforcement part 110 extends from the male connection surface 105 in a direction facing away from the male bottom plate 102 and is electrically connected with the male conductive surrounding frame 108.

As shown in FIG. 1, in some embodiments of the present application, any one of the shielding reinforcement parts 110 is disposed near one of the male signal modules 107, and is disposed between the corresponding male signal module 107 and the male first side plate 103 and/or the male second side plate 104 in the male first direction 106.

In some embodiments of the present application, the region where the shielding reinforcement part 110 is disposed on the male bottom plate 102 is configured as a part of the male conductive surrounding frame 108.

In some embodiments of the present application, at least one of the male signal modules 107 is a differential signal module.

As shown in FIG. 1 (a), in some embodiments of the present application, any one of the shielding reinforcement parts 110 comprises one or more contact terminals 111, the contact terminals 111 are arranged in a male second direction 112, and the male second direction 112 is perpendicular to the male first direction 106 on the plane where the male connection surface 105 is disposed; a root end of each of the contact terminals 111 is fixed to the male bottom plate 102, a free end of each of the contact terminals 111 extends from the male connection surface 105 in a direction facing away from the male bottom plate 102, and the contact terminal 111 is configured to be bent or not bent according to a use environment, and the contact terminal 111 is elastic in case where the contact terminal is bent; in case where each of the shielding reinforcement parts 110 is provided with one or more contact terminals 111, the root ends of the contact terminals 111 are configured to be connected or unconnected.

In some embodiments of the present application, any one of the shielding reinforcement parts 110 comprises one or more metal contact terminals 111, the metal contact terminals 111 are arranged in a male second direction 112, and the male second direction 112 is perpendicular to the male first direction 106 on the plane where the male connection surface 105 is disposed.

As shown in FIG. 1 (b), in some embodiments of the present application, any one of the shielding reinforcement parts 110 comprises two pins 114, the two pins 114 are arranged in a male second direction 112, and the male second direction 112 is perpendicular to the male first direction 106 on the plane where the male connection surface 105 is disposed; a root end of each pin 114 is fixed to the male bottom plate 102, and a free end of each pin 114 extends from the male connection surface 105 in a direction facing away from the male bottom plate 102.

### Embodiment 2

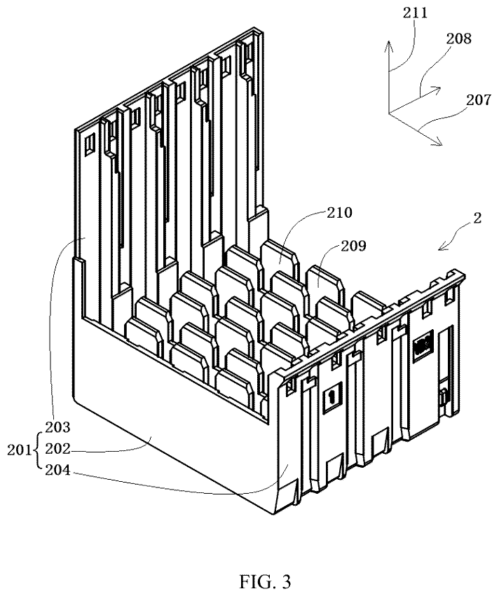

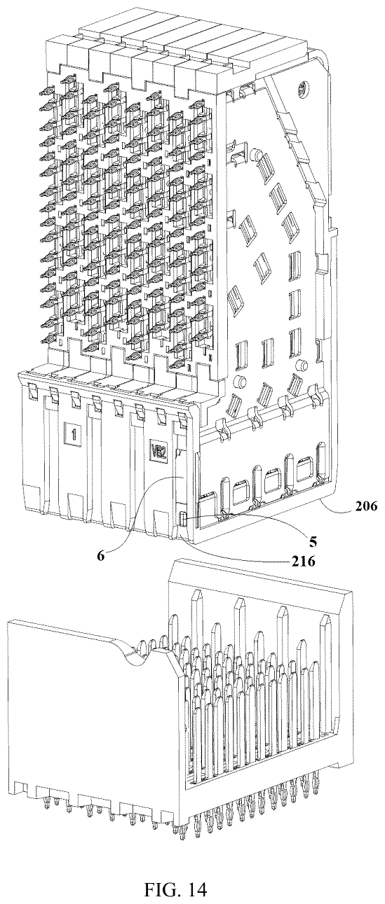

As shown in FIGS. 3-4 and 12-14, a female connector 2 is configured to connect with a male connector 1, and the female connector 2 comprises: a female base 201, the female base 201 is U-shaped from a side view, and the female base 201 comprises a female bottom plate 202, a female first side plate 203 and a female second side plate 204, the female bottom plate 202 is provided with a female connection surface 205 connected with the male connector 1 and a female fixing surface 206 opposite to the female connection surface 205, the female first side plate 203 and the female second side plate 204 are disposed at the two opposite sides of the female bottom plate 202 in a female first direction 207 respectively, and fixedly connected with the female bottom plate 202 to surround the female connection surface 205, the female first direction 207 is disposed at the plane where the female connection surface 205 is disposed; the female bottom plate 202 is provided with a plurality of via holes 217, each of the via holes 217 penetrates through the female connection surface 205 and the female fixing surface 206 of the female bottom plate 202, the plurality of via holes 217 are arranged in a grid in the female first direction 207 and the female second direction 208, and the female second direction 208 is perpendicular to the female first direction 207 on the plane where the female fixing surface 206 is disposed.

As shown in FIGS. 3-4 and 12-14, the female connector 2 further comprises: a female conductive surrounding frame 209, the female conductive surrounding frame 209 is disposed between the female first side plate 203 and the female second side plate 204 and fixed to the female fixing surface 206, the female conductive surrounding frame 209 is provided with a plurality of through slots 210, the plurality of through slots 210 penetrate through the female conductive surrounding frame 209 in a female third direction 211, and the female third direction 211 is perpendicular to the plane where the female fixing surface 209 is disposed.

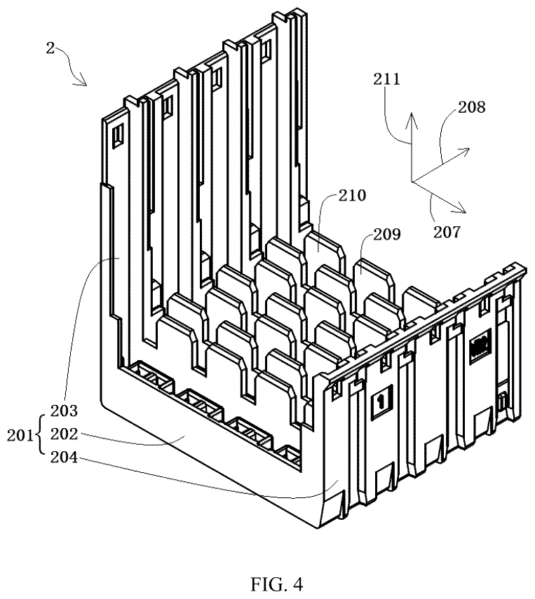

As shown in FIGS. 3-4, the female connector 2 further comprises: one or more conductive terminal modules 212, the conductive terminal modules 212 are configured to be inserted into one of the through slots 210 respectively, any one of the conductive terminal modules 212 is provided with one or more female signal structures 213 and one or more female grounding structures 214, any one of the female signal structures 213 or any one of the female grounding structures 214 is corresponded to one of the via holes 217, all of the female signal structures 213 and the female grounding structures 214 are arranged in a staggered manner one by one on the female connection surface 205 of the female bottom plate 202, and all of the female grounding structures 214 are electrically connected with the female conductive surrounding frame 209 and then connected to the ground.

As shown in FIGS. 3-4, one or more ground terminal mounting slots 215 are disposed on the female first side plate 203 and/or the female second side plate 204, the ground terminal mounting slot 215 extends from the female connection surface 205 in the female third direction 211 facing away from the female bottom plate 202, and exposes the female conductive surrounding frame 209 disposed at a corresponding position.

As shown in FIGS. 3-4, in some embodiments of the present application, the ground terminal mounting slot 215 exposes the female conductive surrounding frame 209 disposed at a corresponding position, and the electrical connection piece 216 is provided.

As shown in FIGS. 3-4, in some embodiments of the present application, any one of the ground terminal mounting slots 215 is disposed near one of the female signal structures 213, andis arranged correspondently with the corresponding female signal structure 213 in the female first direction 207; the ground terminal mounting slot 215 is provided with one or more channels 2151, in case where there are two or more channels 2151, the channels 2151 are arranged in parallel and locally connected, the ground terminal mounting slot 215 is provided with the electrical connection piece 216.

As shown in FIG. 3 and FIG. 4, in some embodiments of the present application, the electrical connection piece 216 comprises a bump (not labeled), a protruding side of the bump faces away from a corresponding female first side plate or the female second side plate, the bump is electrically connected to a corresponding component in the male connector 1 in an interference fit manner.

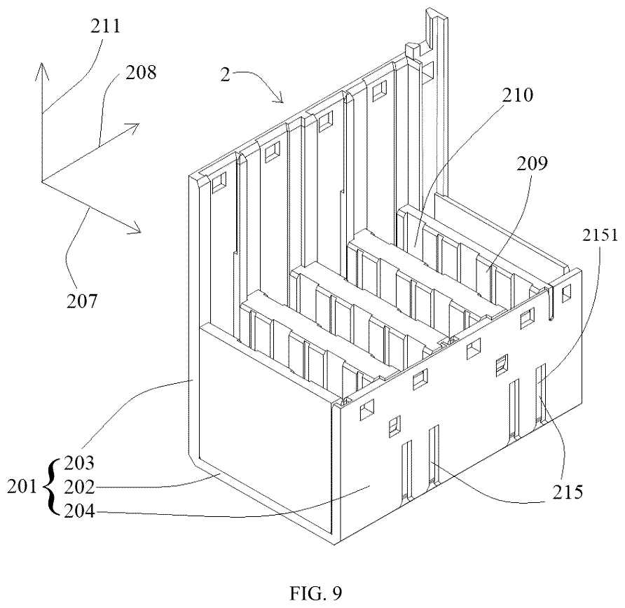

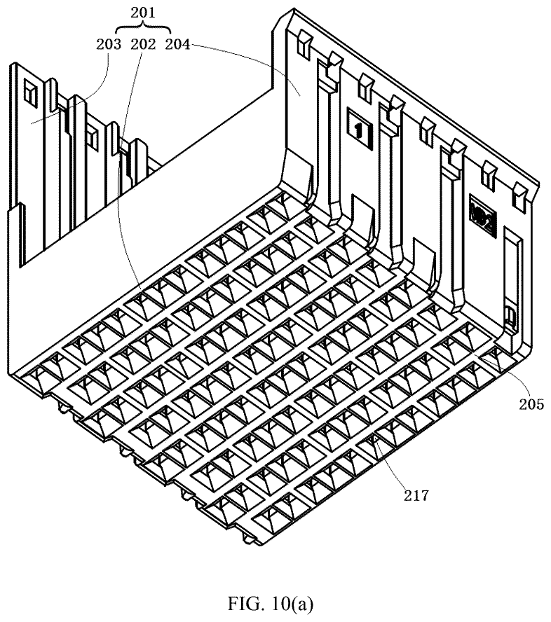

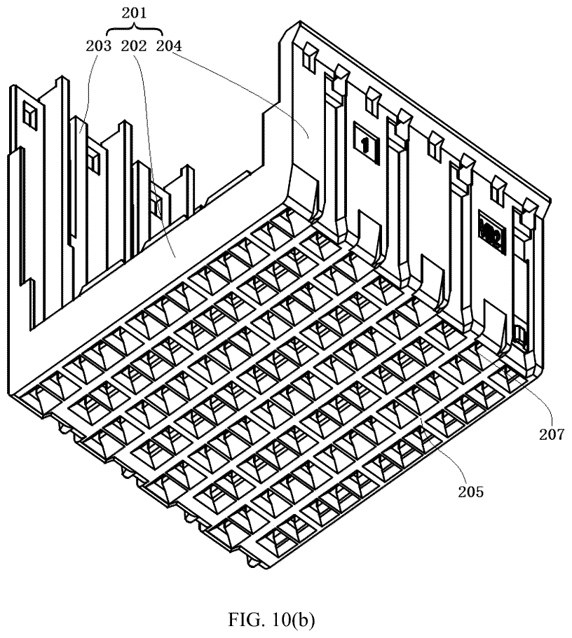

As shown in FIG. 9 and FIG. 10, in some embodiments of the present application, the ground terminal mounting slot 215 comprises two parallel and partially communicated channels 2151, and the ground terminal mounting slot 215 is not provided with the electrical connection piece 216.

### Embodiment 3

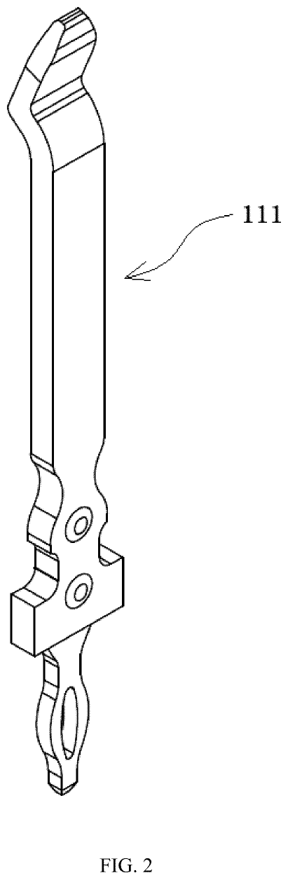

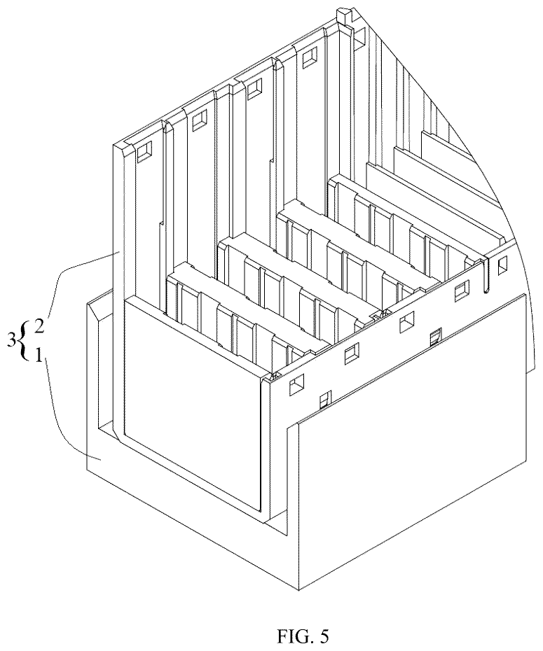

As shown in FIGS. 1-5, a connector combination 3, the connector combination 3 comprises a male connector 1 and a female connector 2 configured to be connected mutually, and the male connector 1 is as described in Embodiment 1, and the female connector 2 is as described in Embodiment 2. The male connection surface 105 of the male bottom plate 102 and the female connection surface 205 of the female bottom plate 202 are connected face to face, and each of the shielding reinforcement parts 110 is separately inserted into one of the ground terminal mounting slots 215; the ground terminal mounting slot 215 is provided with an electrical connection piece 216, the electrical connection piece comprises a protruding structure, the protruding structure is connected with the shielding reinforcement part; therefore, shielding protection of each signal piece in the male connector and the female connector is achieved, and signal crosstalk is reduced.

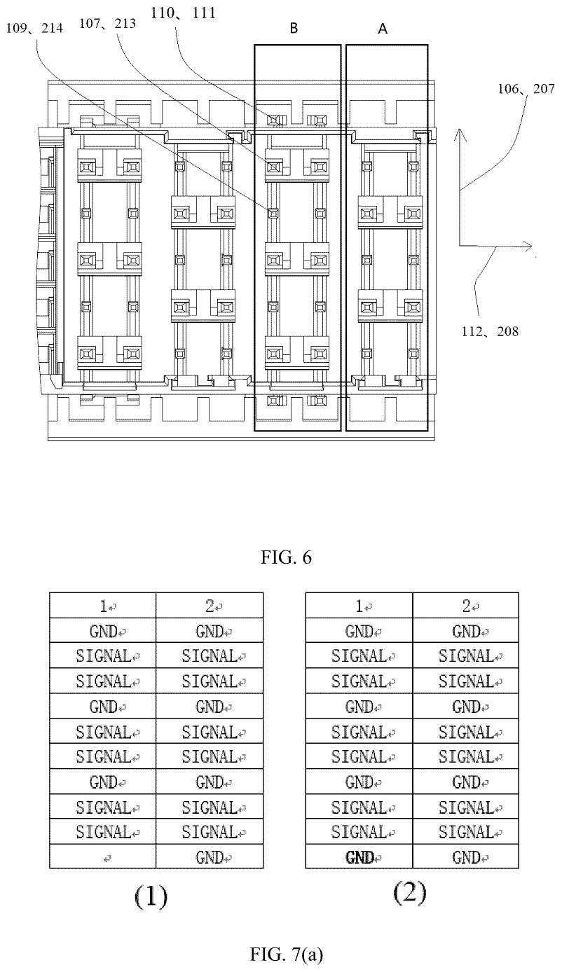

As shown in FIG. 1, FIG. 3 and FIG. 6, in some embodiments of the present application, one or more shielding reinforcement parts 110 is disposed at a connection between the male bottom plate 102 and the male first side plate 103 and/or at a connection between the male bottom plate 102 and the male second side plate 104, the shielding reinforcement part 110 extends from the male connection surface 105 in a direction facing away from the male bottom plate 102, and is electrically connected with the male conductive surrounding frame 108.

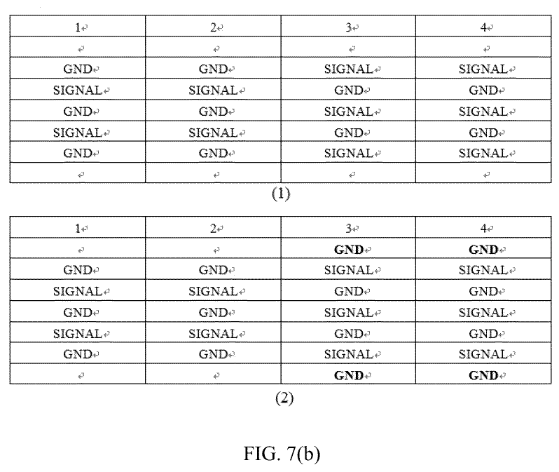

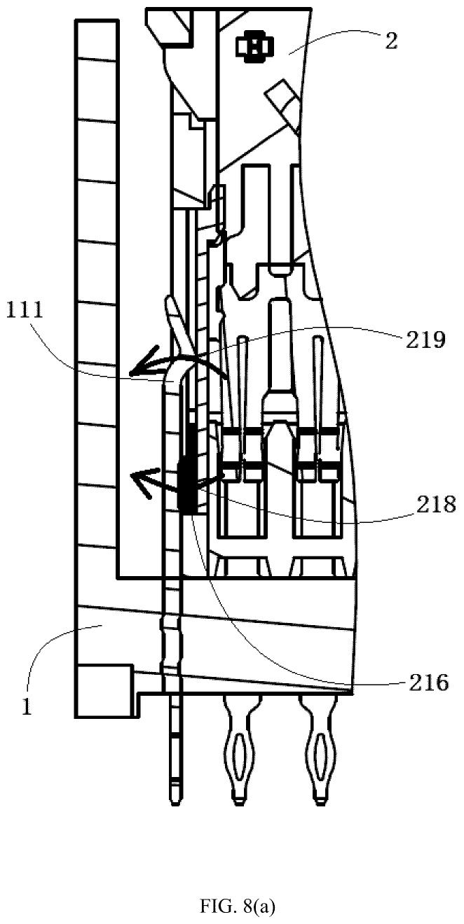

In some embodiments of the present application, the shielding reinforcement part 110 is disposed near the male signal module 107, and the shielding reinforcement part 110 is disposed between the corresponding male signal module 107 and the male first side plate 103 or the male second side plate 104 in the male first direction 106; any one of the ground terminal mounting slots 215 is disposed near one of the female signal structures 213, and the ground terminal mounting slot 215 is arranged correspondently with the corresponding female signal structure 213 in the female first direction 207; the male first direction 106 is the same as the female first direction 207, and the male second direction 112 is the same as the female second direction 208. As shown in FIG. 6, in some embodiments of the present application, in the female first direction 207 or the male first direction 106, the signal modules and the grounding modules of the male connector and the female connector form a column A in the arrangement manner of the signal module-grounding module-signal module-grounding module-signal module, and the signal modules and the grounding modules of the male connector and the female connector form a column B in the arrangement manner of the grounding module-signal module-grounding module-signal module-grounding module, and the shielding reinforcement part 110 and the ground terminal mounting slot 215 are arranged on the outer sides of the signal modules disposed at the two ends of the outermost edge of the column A, so that a good shielding effect can be obtained by the signal modules at the two ends of the outermost edge and the performance of the connector combination is enhanced; in existing art, the outer sides of the signals at the two ends of the outermost edge of the column A are not provided with the shielding reinforcement part 110 and the ground terminal mounting slot 215, so that the shielding effect of the signal module disposed at the outermost edge in the existing art is relatively poor, and the shielding effect of the signal module disposed at the outermost edge is optimized in the present application. FIG. 7 (a) and FIG. 7 (b) are comparison schematic diagrams of effects of the present application and the existing art, wherein GND in FIG. 7 (a) and FIG. 7 (b) refers to a ground terminal, that is, the shielding reinforcement part 110 can provide an additional grounding effect, and SIGNAL refers to a signal terminal, that is, signal terminal of the male signal module 107 and the female signal structure 213; (1) in FIG. 7 (a) is the art known by the inventor, and (2) in FIG. 7 (a) is a specific embodiment of the present application; (1) in FIG. 7 (b) is the art known by the inventor, FIG. 7 (b) is another specific embodiment of the present application. Specifically, as shown in (1) in FIG. 7 (a), the first column is an arrangement of “ground-signal-signal-ground-signal-signal-ground-signal-signal”, and the second column is an arrangement of “ground-signal-signal-ground-signal-signal-ground-signal-signal-ground”, and it can be seen that signal module disposed at one edge of the first column is not provided with ground shielding protection, so that the signal is interfered by crosstalk and the like, thereby affecting the quality of signal transmission; as shown in (2) in FIG. 7 (a), the first column is an arrangement of “ground-signal-signal-ground-signal-signal-ground-signal-signal-ground”, the second column is an arrangement of “ground-signal-signal-ground-signal-signal-ground-signal-signal-ground”, and it can be seen that the technical solution provided in the present application can enable the signal module disposed at the edge of the first column to obtain the ground shielding protection, thereby the quality of signal transmission is improved. FIG. 7 (b) is another specific embodiment of the present application, specifically, as shown in (1) in FIG. 7 (b), the arrangement manners of the first column and the second column are both “ground-signal-ground-signal-ground”, and the arrangement manners of the third column and the fourth column are both “ground-signal-ground-signal-ground-signal”, and it can be seen that the signal module disposed at one edge of the third column and the fourth column cannot obtain ground shielding protection; as shown in (2) in FIG. 7 (b), the signal modules disposed at the edges of the third column and the fourth column both obtain the ground shielding protection, and at this time, the transmission quality of the signal is improved.

As shown in FIG. 3 and FIG. 4, in some embodiments of the present application, the ground terminal mounting slot 215 is provided with an electrical connection piece 216; the male connection surface 105 of the male bottom plate 102 and the female connection surface 205 of the female bottom plate 202 are connected face to face, and an outer side of each of the shielding reinforcement parts 110 separately close to one of the ground terminal mounting slots 215 is electrically connected with the electrical connection piece 216. As shown in FIG. 3 and FIG. 4, in some embodiments of the present application, the electrical connection piece 216 is in the form of a bump, and the bump is connected to the shielding reinforcement part 110 in a way of interference fit to achieve electrical connection.

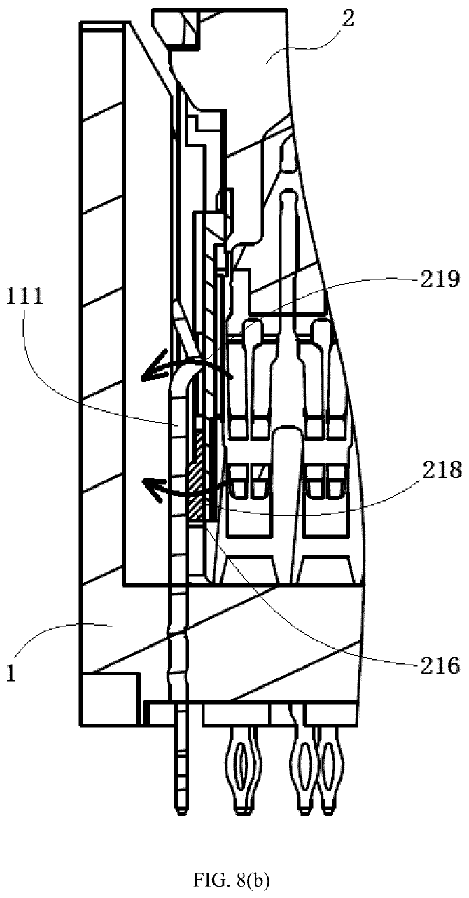

As shown in FIG. 1 (a) and FIG. 8, in some embodiments of the present application, any one of the shielding reinforcement parts 110 comprises two pins 114, the two pins 114 are arranged in the male second direction 112, and the male second direction 112 is perpendicular to the male first direction 106 on the plane where the male connection surface 105 is disposed; a root end of each bending reed 111 is fixed to the male bottom plate 102, a free end of each bending reed 111 extends from the male connection surface 105 in a direction facing away from the male bottom plate 102, and the free end of each bending reed 111 is bent to have elasticity; a free end of the bending reed 111 comprises a first contact portion 218 and a second contact portion 219, the first contact portion 218 is electrically connected to the electrical connection piece 216, the second contact portion 219 is connected with the female conductive surrounding frame 209, and at this time, two backflow paths are formed and constitutes an encircling backflow structure, the overall grounding shielding effect of the product is enhanced and signal crosstalk is reduced by the encircling backflow structure.

As shown in FIG. 1 (b), in some embodiments of the present application, any one of the shielding reinforcement parts 110 comprises two pins 114, the two pins 114 are arranged in a male second direction 112, and the male second direction 112 is perpendicular to the male first direction 106 on the plane where the male connection surface 105 is disposed; the root end of each pin 114 is fixed to the male bottom plate 102, and the free end of each pin 114 extends from the male connection surface 105 in a direction facing away from the male bottom plate 102; and the pin 114 is electrically connected to the electrical connection piece, and the pin 114 is provided with only one contact position, and the shielding effect to the signal modules disposed at the edge of two ends of the column is enhanced in case where the pin 114 is configured as the shielding reinforcement part 110.

In some embodiments of the present application, the pin 114 is configured as the shielding reinforcement part 110, only one contact portion is provided between the pin 114 and the bump, and at this time, an antenna effect is generated by the free end disposed on the other end of the contact portion disposed on the pin 114, so that loss and crosstalk are generated on the signal, the performance of the connector combination 3 is reduced. As shown in FIG. 8, in some embodiments of the present application, the bending reed 111 is configured as the shielding reinforcement part 110, a partial region of the bending reed 111 is in contact with the bump so as to be indirectly electrically connected to the female conductive surrounding frame 209, and another partial region of the bending reed 111 is directly connected to the female conductive surrounding frame 209, that is, two backflow paths can be formed at the position of the ground terminal mounting slot 215 by the combination of the bending reed 111 and the bump, the two backflow paths form an encircling structure, and the two backflow paths are as illustrated by two arrows shown in FIG. 8, so that the encircling type backflow design not only can enhance the shielding effect on the signal modules disposed at the edge of two ends of the column, but also can alleviate the antenna effect possibly caused by the structural characteristics in case where the pin 114 is adopted, thereby the shielding effect is improved and the performance of the connector combination is enhanced.

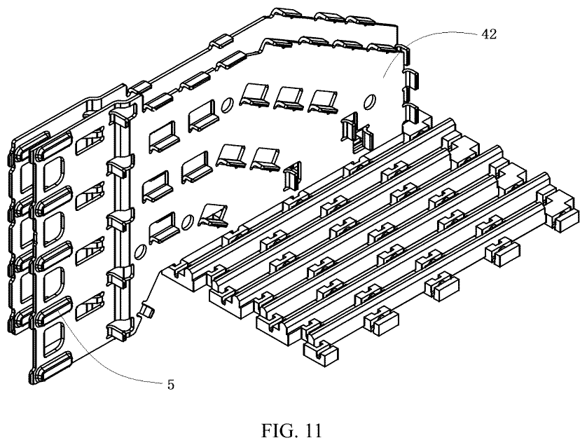

As shown in FIG. 11, in some embodiments of the present application, the shielding plate 42 is provided with a bulge 5, and the shielding plate 42 abuts against the pin 114 via the drum 5. Specifically, in case where the bulge 5 abuts against the pin 114 in the male connector 1, the bulge 5 can be in sufficient contact with the pin 114 of the male connector 1 due to the characteristic that the bulge 5 has a large protrusion area. Moreover, by processing the bulge 5 at different heights, the tightness of the contact between the shield plate 42 and the pin 11 of the male connector 1 can be changed. In addition, compared with the form of the elastic piece, the above-mentioned abutting mode of the bulge 5 is less prone to deformation, and therefore, the stability of the contact between the bulge 5 and the pin 114 is stronger, so as to play a role in shortening the backflow path and reducing crosstalk.

### Embodiment 4

As shown in FIG. 1, in an embodiment of the present application, a male connector 1, the male connector 1 is configured to connect with a female connector 2, and the male connector 1 comprises: a male base 101, the male base 101 is U-shaped from a side view, the male base 101 comprises a male bottom plate 102, a male first side plate 103 and a male second side plate 104, the male bottom plate 102 is provided with a male connection surface 105 connected with the female connector 2, the male first side plate 103 and the male second side plate 104 are disposed at the two opposite sides of the male bottom plate 102 in a male first direction 106 respectively, and fixedly connected with the male bottom plate 102 to surround the male connection surface 105, the male first direction 106 is disposed at the plane where the male connection surface 105 is disposed; a partial region of the male bottom plate 102 is hollowed out, a plurality of male signal modules 107 are disposed in the partial region, the plurality of male signal modules 107 extend from the male connection surface 105 in a direction facing away from the male bottom plate 102, in case where the male connector 1 is connected with the female connector 2, the plurality of male signal modules 107 are inserted into the female connector 2.

As shown in FIG. 1, the male connector 1 further comprises: a male conductive surrounding frame 108, the male conductive surrounding frame 108 is configured to be embedded in a hollowed-out region of the male bottom plate 102 and substantially coplanar with the male bottom plate 102, and a plurality of male grounding modules 109 are disposed on the male conductive surrounding frame 108, the plurality of male grounding modules 109 extend from the male connection surface 105 in a direction facing away from the male bottom plate 102, the male grounding module 109 and the male signal module 107 are arranged in a staggered manner one by one and shaped as a grid, and the male grounding module 109 is electrically connected with the male conductive surrounding frame 108 and then connected to the ground.

As shown in FIG. 1, the male connector 1 further comprises a plurality of shielding reinforcement parts 110, the shielding reinforcement part 110 is disposed at a connection between the male bottom plate 102 and the male first side plate 103 and/or at a connection between the male bottom plate 102 and the male second side plate 104, the plurality of shielding reinforcement parts 110 extend from the male connection surface 105 in a direction facing away from the male bottom plate 102, and is electrically connected with the male conductive surrounding frame 108.

As shown in FIGS. 3-4, a female connector 2 is configured to connect with a male connector 1, and the female connector 2 comprises: a female base 201, the female base 201 is U-shaped from a side view, the female base 201 comprises a female bottom plate 202, a female first side plate and a female second side plate, the female bottom plate 202 is provided with a female connection surface 205 connected with the male connector 1 and a female fixing surface opposite to the female connection surface, the female first side plate and the female second side plate are disposed at the two opposite sides of the female bottom plate 202 in a female first direction 207 respectively, and fixedly connected with the female bottom plate 202 to surround the female connection surface, the female first direction 207 is disposed at the plane where the female connection surface is disposed; the female bottom plate 202 is provided with a plurality of via holes 217, each of the via holes 217 penetrates through the female connection surface and the female fixing surface of the female bottom plate 202, the plurality of via holes 217 are arranged in a grid in the female first direction 207 and the female second direction 208, the female second direction 208 is perpendicular to the female first direction 207 on the plane where the female fixing surface is disposed.

As shown in FIGS. 3-4, the female connector 2 further comprises: a female conductive surrounding frame 209, the female conductive surrounding frame 209 is disposed between the female first side plate and the female second side plate and fixed to the female fixing surface, the female conductive surrounding frame 209 is provided with a plurality of through slots 210, the plurality of through slots 210 penetrate through the female conductive surrounding frame 209 in a female third direction 211, the female third direction 211 is perpendicular to the plane where the female fixing surface is disposed.

As shown in FIGS. 3-4, the female connector 2 further comprises: a plurality of conductive terminal modules 212, the conductive terminal modules 212 are configured to be inserted into one of the through slots 210 respectively, any one of the conductive terminal modules 212 is provided with a plurality of female signal structures 213 and a plurality of female grounding structures 214, any one of the female signal structures 213 or any one of the female grounding structures 214 is corresponded to one of the via holes 217, all of the female signal structures 213 and the female grounding structures 214 are arranged in a staggered manner one by one on the female connection surface 205 of the female bottom plate 202, and all of the female grounding structures 214 are electrically connected with the female conductive surrounding frame 209 and then connected to the ground.

As shown in FIGS. 3-4, a plurality of ground terminal mounting slots 215 are disposed on the female first side plate 203 and/or the female second side plate 204, the plurality of ground terminal mounting slots 215 extend from the female connection surface 205 in the female third direction 211 facing away from the female bottom plate 202, and expose the female conductive surrounding frame 209 disposed at a corresponding position.

The male connection surface 105 of the male bottom plate 102 and the female connection surface 205 of the female bottom plate 202 are connected face to face, each of the shielding reinforcement parts 110 is separately inserted into one of the ground terminal mounting slots 215, and is connected to the corresponding female conductive surrounding frame 209.

### Mbodiment 5

A connector combination 3, the connector combination 3 comprises a male connector 1 and a female connector 2 configured to be connected with each other, the male connector 1 comprises: a male base 101, the male base 101 is U-shaped from a side view, the male base 101 comprises a male bottom plate 102, a male first side plate 103 and a male second side plate 104, the male bottom plate 102 is provided with a male connection surface 105 connected with the female connector 2, the male first side plate 103 and the male second side plate 104 are disposed at the two opposite sides of the male bottom plate 102 in a male first direction 106 respectively, and fixedly connected with the male bottom plate 102 to surround the male connection surface 105, the male first direction 106 is disposed at the plane where the male connection surface 105 is disposed; a partial region of the male bottom plate 102 is hollowed out, a plurality of male signal modules 107 are disposed in the partial region, and the plurality of male signal modules 107 extend from the male connection surface 105 in a direction facing away from the male bottom plate 102; a male conductive surrounding frame 108, the male conductive surrounding frame 108 is configured to be embedded in a hollowed-out region of the male bottom plate 102 and substantially coplanar with the male bottom plate 102, and a plurality of male grounding modules 109 are disposed on the male conductive surrounding frame 108, the plurality of male grounding modules 109 extend from the male connection surface 105 in a direction facing away from the male bottom plate 102, the male grounding module 109 and the male signal module 107 are arranged in a staggered manner one by one and shaped as a grid, and the male grounding module 109 is electrically connected with the male conductive surrounding frame 108 and then connected to the ground; one or more shielding reinforcement parts 110, the shielding reinforcement part 110 is disposed at a connection between the male bottom plate 102 and the male first side plate 103 and/or at a connection between the male bottom plate 102 and the male second side plate 104, the shielding reinforcement part 110 extends from the male connection surface 105 in a direction facing away from the male bottom plate 102 and is electrically connected with the male conductive surrounding frame 108; the female connector 2 comprises: a female base 201, the female base 201 is U-shaped from a side view, and the female base 201 comprises a female bottom plate 202, a female first side plate 203 and a female second side plate 204, the female bottom plate 202 is provided with a female connection surface 205 connected with the male connector 1 and a female fixing surface 206 opposite to the female connection surface 205, the female first side plate 203 and the female second side plate 204 are disposed at the two opposite sides of the female bottom plate 202 in a female first direction 207 respectively, and fixedly connected with the female bottom plate 202 to surround the female connection surface 205, the female first direction 207 is disposed at the plane where the female connection surface 205 is disposed; the female bottom plate 202 is provided with a plurality of via holes 217, each of the via holes 217 penetrates through the female connection surface 205 and the female fixing surface 206 of the female bottom plate 202, the plurality of via holes 217 are arranged in a grid in the female first direction 207 and the female second direction 208, the female second direction 208 is perpendicular to the female first direction 207 on the plane where the female fixing surface 206 is disposed; one or more ground terminal mounting slots 215 are disposed on the female first side plate 203 and/or the female second side plate 204, the ground terminal mounting slot 215 extends from the female connection surface 205 in the female third direction 211 facing away from the female bottom plate 202; the ground terminal mounting slot 215 is provided with the electrical connection piece 216, the electrical connection piece 216 comprises a protruding structure, a protruding side of the protruding structure faces away from a corresponding female first side plate 203 or the female second side plate 204.

In some embodiments of the present application, the female connector 2 further comprises: a female conductive surrounding frame 209, the female conductive surrounding frame 209 is disposed between the female first side plate 203 and the female second side plate 204 and fixed to the female fixing surface 206, the female conductive surrounding frame 209 is provided with a plurality of through slots 210, the plurality of through slots 210 penetrate through the female conductive surrounding frame 209 in a female third direction 211, and the female third direction 211 is perpendicular to the plane where the female fixing surface206 is disposed; one or more conductive terminal modules 212, configured to be inserted into one of the through slots 210, any one of the conductive terminal modules 212 is provided with one or more female signal structures 213 and one or more female grounding structures 214, any one of the female signal structures 213 or any one of the female grounding structures 214 is corresponded to one of the via holes 217, all of the female signal structures 213 and the female grounding structures 214 are arranged in a staggered manner one by one on the female connection surface 205 of the female bottom plate 202, all of the female grounding structures 214 are electrically connected with the female conductive surrounding frame 209 and then connected to the ground; the ground terminal mounting slot 215 exposes the female conductive surrounding frame 209 disposed at a corresponding position, and the electrical connection piece 216 is provided ; the male connection surface 105 of the male bottom plate 102 and the female connection surface 205 of the female bottom plate 202 are connected face to face, and each of the shielding reinforcement parts 110 is separately inserted into one of the ground terminal mounting slots 215, and is connected with the electrical connection piece 216 and/or the female conductive surrounding frame 209.

In some embodiments of the present application, the female connector 2 further comprises: one or more conductive reinforcement parts, the conductive reinforcement part is disposed at a connection between the female bottom plate 202 and the female first side plate 203 and/or at a connection between the female bottom plate 202 and the female second side plate 204, or disposed in the female first side plate 203 and/or the female second side plate 204; one or more conductive terminal modules 212, configured to be inserted into the via hole 217 on the female base 201, any one of the conductive terminal modules 212 is provided with one or more female signal structures 213 and one or more female grounding structures 214, any one of the female signal structures 213 or any one of the female grounding structures 214 is corresponded to one of the via holes 217, all of the female signal structures 213 and the female grounding structures 214 are arranged in a staggered manner one by one on the female connection surface 205 of the female bottom plate 202; the conductive reinforcement part is electrically connected to the female grounding structure 214; the ground terminal mounting slot 215 exposes the conductive reinforcement part disposed at a corresponding position, and the electrical connection piece 216 is provided; the male connection surface 105 of the male bottom plate 102 and the female connection surface 205 of the female bottom plate 202 are connected face to face, each of the shielding reinforcement parts 110 is separately inserted into one of the ground terminal mounting slots 215, and is connected to the corresponding female electrical connection piece 216 and/or the conductive reinforcement part.

In some embodiments of the present application, any one of the shielding reinforcement parts 110 is disposed near one of the male signal modules 107, and disposed between the corresponding male signal module 107 and the male first side plate 103 and/or the male second side plate 104 in the male first direction 106; any one of the ground terminal mounting slots 215 is disposed near one of the female signal structures, and is arranged correspondently with the corresponding female signal structure in the female first direction 207; the male first direction 106 is the same as the female first direction 207; the male connection surface 105 of the male bottom plate 102 and the female connection surface 205 of the female bottom plate 202 are connected face to face, and an outer side of each of the shielding reinforcement parts 110 separately close to one of the ground terminal mounting slots 215 is electrically connected with the electrical connection piece 216; any one of the shielding reinforcement parts 110 comprises one or more contact terminals, the contact terminals are arranged in a male second direction 112, and the male second direction 112 is perpendicular to the male first direction 106 on the plane where the male connection surface 105 is disposed; a root end of each of the contact terminals is fixed to the male bottom plate 102, a free end of each of the contact terminals extends from the male connection surface 105 in a direction facing away from the male bottom plate 102, the contact terminal is configured to be bent or not bent according to a use environment, the contact terminal 111 is elastic in case where the contact terminal is bent; in case where the contact terminal is bent, the free end of the contact terminal comprises a first contact portion 218 and a second contact portion 219, the first contact portion 218 is electrically connected to the electrical connection piece 216, the second contact portion 219 is connected with the female conductive surrounding frame 209; any one of the shielding reinforcement parts 110 at least comprises one or more metal contact terminals, the metal contact terminals are arranged in a male second direction 112, the male second direction 112 is perpendicular to the male first direction 106 on the plane where the male connection surface 105 is disposed; the root end of each of the metal contact terminals is fixed to the male bottom plate 102, the free end of each of the metal contact terminals extends from the male connection surface 105 in a direction facing away from the male bottom plate 102; the metal contact terminal is electrically connected with the electrical connection piece 216.

### Embodiment 6

A connector combination 3, the connector combination 3 comprises a male connector 1 and a female connector 2 configured to be connected mutually, the male connector 1 comprises: a male base 101, the male base 101 is U-shaped from a side view, the male base 101 comprises a male bottom plate 102, a male first side plate 103 and a male second side plate 104, the male bottom plate 102 is provided with a male connection surface 105 connected with the female connector 2, the male first side plate 103 and the male second side plate 104 are disposed at the two opposite sides of the male bottom plate 102 in a male first direction 106 respectively, and fixedly connected with the male bottom plate 102 to surround the male connection surface 105, the male first direction 106 is disposed at the plane where the male connection surface 105 is disposed; a partial region of the male bottom plate 102 is hollowed out, a plurality of male signal modules 107 are disposed in the partial region, and the plurality of male signal modules 107 are configured to extend from the male connection surface 105 in a direction facing away from the male bottom plate 102; a male conductive surrounding frame 108, the male conductive surrounding frame 108 is configured to be embedded in a hollowed-out region of the male bottom plate 102 and substantially coplanar with the male bottom plate 102, and a plurality of male grounding modules 109 are disposed on the male conductive surrounding frame 108, the plurality of male grounding modules 109 extend from the male connection surface 105 in a direction facing away from the male bottom plate 102, the male grounding module 109 and the male signal module 107 are arranged in a staggered manner one by one and shaped as a grid, and the male grounding module 109 is electrically connected with the male conductive surrounding frame 108 and then connected to the ground; one or more shielding reinforcement parts 110, the shielding reinforcement part 110 is disposed at a connection between the male bottom plate 102 and the male first side plate 103 and/or at a connection between the male bottom plate 102 and the male second side plate 104, the shielding reinforcement part 110 extends from the male connection surface 105 in a direction facing away from the male bottom plate 102 and is electrically connected with the male conductive surrounding frame 108; the female connector 2 comprises: a female base 201, the female base 201 is U-shaped from a side view, and the female base 201 comprises a female bottom plate 202, a female first side plate 203 and a female second side plate 204, the female bottom plate 202 is provided with a female connection surface 205 connected with the male connector 1 and a female fixing surface 206 opposite to the female connection surface 205, the female first side plate 203 and the female second side plate 204 are disposed at the two opposite sides of the female bottom plate 202 in a female first direction 207 respectively, and fixedly connected with the female bottom plate 202 to surround the female connection surface 205, the female first direction 207 is disposed at the plane where the female connection surface 205 is disposed; the female bottom plate 202 is provided with a plurality of via holes 217, each of the via holes 217 penetrates through the female connection surface 205 and the female fixing surface 206 of the female bottom plate 202, the plurality of via holes 217 are arranged in a grid in the female first direction 207 and the female second direction 208, the female second direction 208 is perpendicular to the female first direction 207 on the plane where the female fixing surface 206 is disposed; one or more ground terminal mounting slots 215 are disposed on the female first side plate 203 and/or the female second side plate 204, the ground terminal mounting slot 215 extends from the female connection surface 205 in the female third direction 211 facing away from the female bottom plate 202; the ground terminal mounting slot 215 is provided with the electrical connection piece 216, the electrical connection piece 216 comprises a protruding structure, and a protruding side of the protruding structure faces away from a corresponding female first side plate 203 or the female second side plate 204, the protruding structure is connected to the shielding reinforcement part 110.

In some embodiments of the present application, the female connector 2 further comprises: a female conductive surrounding frame 209, the female conductive surrounding frame 209 is disposed between the female first side plate 203 and the female second side plate 204 and fixed to the female fixing surface 206, the female conductive surrounding frame 209 is provided with a plurality of through slots 210, the plurality of through slots 210 penetrate through the female conductive surrounding frame 209 in a female third direction 211, and the female third direction 211 is perpendicular to the plane where the female fixing surface206 is disposed; one or more conductive terminal modules 212, configured to be inserted into one of the through slots 210, any one of the conductive terminal modules 212 is provided with one or more female signal structures 213 and one or more female grounding structures 214, any one of the female signal structures 213 or any one of the female grounding structures 214 is corresponded to one of the via holes 217, all of the female signal structures 213 and the female grounding structures 214 are arranged in a staggered manner one by one on the female connection surface 205 of the female bottom plate 202, all of the female grounding structures 214 are electrically connected with the female conductive surrounding frame 209 and then connected to the ground; the ground terminal mounting slot 215 exposes the female conductive surrounding frame 209 corresponding to the ground terminal mounting slot 215, and the electrical connection piece 216 is provided; each of the shielding reinforcement parts 110 is separately connected with the electrical connection piece 216 and/or the conductive surrounding frame.

In some embodiments of the present application, the female connector 2 further comprises: one or more conductive reinforcement parts, the conductive reinforcement part is disposed at a connection between the female bottom plate 202 and the female first side plate 203 and/or a connection between the female bottom plate 202 and the female second side plate 204, or disposed in the female first side plate 203 and/or the female second side plate 204; one or more conductive terminal modules 212, configured to be inserted into the via hole 217 on the female base 201, any one of the conductive terminal modules 212 is provided with one or more female signal structures 213 and one or more female grounding structures 214, any one of the female signal structures 213 or any one of the female grounding structures 214 is corresponded to one of the via holes 217, all of the female signal structures 213 and the female grounding structures 214 are arranged in a staggered manner one by one on the female connection surface 205 of the female bottom plate 202; the conductive reinforcement part is electrically connected to the female grounding structure 214; the ground terminal mounting slot 215 exposes the conductive reinforcement part disposed at a corresponding position, and the electrical connection piece 216 is provided; each of the shielding reinforcement pieces 110 is separately connected to the corresponding electrical connection piece 216 and/or the conductive reinforcement part.

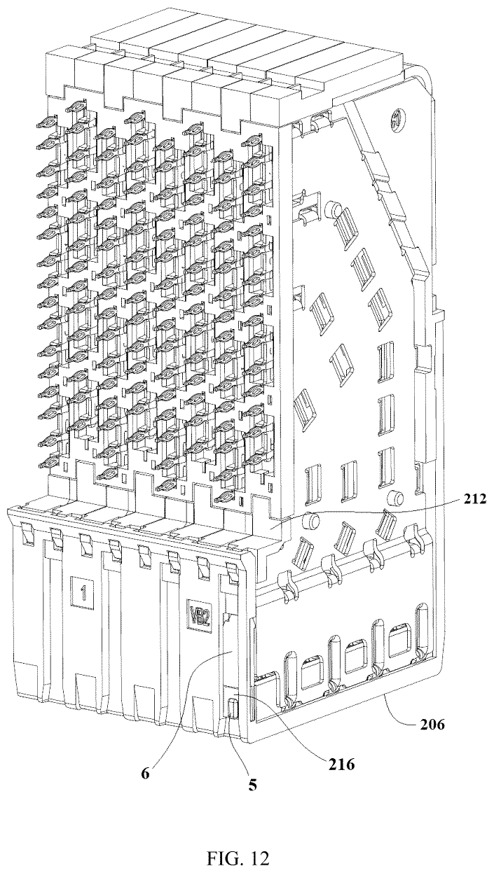

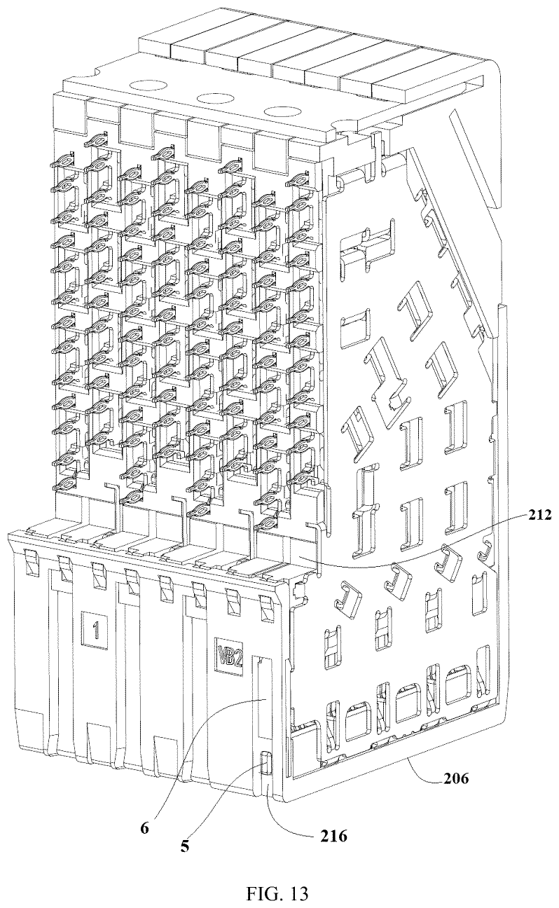

Referring to FIG. 12 to FIG. 14, in some embodiments of the present application, the conductive reinforcement part 6 is connected to the electrical connection piece 216 having the bulge 5 to provide shielding protection for signal transmission, thereby avoiding crosstalk.

In the description of the present specification, specific features, structures, materials, or characteristics may be combined in any suitable manner in any one or more embodiments or examples. The embodiments of the present application have been described in detail above, and the principle and implementation manners of the present application are described herein by using specific examples, and the descriptions of the above embodiments are only used to help understand the method and the core idea of the present application; at the same time, for those skilled in the art, according to the idea of the present application, there may be changes in specific implementations and application ranges, and in conclusion, the content of this specification should not be understood as a limitation to this application.

1. A male connector, configured to be connected with a female connector, wherein the male connector comprises:
a male base, the male base is U-shaped from a side view, and the male base comprises a male bottom plate, a male first side plate and a male second side plate, the male bottom plate is provided with a male connection surface connected with the female connector, the male first side plate and the male second side plate are disposed at the two opposite sides of the male bottom plate in a male first direction respectively, and fixedly connected with the male bottom plate to surround the male connection surface, the male first direction is disposed at the plane where the male connection surface is disposed; a partial region of the male bottom plate is hollowed out, one or more male signal modules are disposed in the partial region, and the male signal module extends from the male connection surface in a direction facing away from the male bottom plate;
a male conductive surrounding frame, configured to be embedded in a hollowed-out region of the male bottom plate and substantially coplanar with the male bottom plate, one or more male grounding modules are disposed on the male conductive surrounding frame, the one or more male grounding modules extend from the male connection surface in a direction facing away from the male bottom plate, the male grounding module and the male signal module are arranged in a staggered manner one by one and shaped as a grid, and the male grounding module is electrically connected with the male conductive surrounding frame and then connected to the ground;
one or more shielding reinforcement parts, configured to be disposed at a connection between the male bottom plate and the male first side plate and/or at a connection between the male bottom plate and the male second side plate, the shielding reinforcement part extends from the male connection surface in a direction facing away from the male bottom plate and is electrically connected with the male conductive surrounding frame.

2. The male connector according to claim 1, wherein any one of the shielding reinforcement parts is disposed near one of the male signal modules, and the shielding reinforcement part is disposed between the corresponding male signal module and the male first side plate and/or between the corresponding male signal module and the male second side plate in the male first direction;
the region of the male bottom plate where the shielding reinforcement part is disposed is configured as a part of the male conductive surrounding frame.

3. The male connector according to claim 1, wherein at least one of the male signal modules is a differential signal module;
any one of the shielding reinforcement parts comprises one or more contact terminals, the contact terminals are arranged in a male second direction, and the male second direction is perpendicular to the male first direction on the plane where the male connection surface is disposed;
a root end of each of the contact terminals is fixed to the male bottom plate, a free end of each of the contact terminals extends from the male connection surface in a direction facing away from the male bottom plate, and the contact terminal is configured to be bent or not bent according to a use environment, and the contact terminal is elastic in case where the contact terminal is bent;
in case where each of the shielding reinforcement pieces is provided with one or more contact terminals, the root ends of the contact terminals are configured to be connected or unconnected.

4. The male connector according to claim 1, wherein any one of the shielding reinforcement parts comprises one or more metal contact terminals, the metal contact terminals are arranged in a male second direction, and the male second direction is perpendicular to the male first direction on the plane where the male connection surface is disposed.

5. A female connector, configured to be connected with a male connector, wherein the female connector comprises:
a female base, the female base is U-shaped from a side view, and the female base comprises a female bottom plate, a female first side plate and a female second side plate, the female bottom plate is provided with a female connection surface connected with the male connector and a female fixing surface opposite to the female connection surface, the female first side plate and the female second side plate are disposed at the two opposite sides of the female bottom plate in a female first direction respectively, and fixedly connected with the female bottom plate to surround the female connection surface, the female first direction is disposed at the plane where the female connection surface is disposed; the female bottom plate is provided with a plurality of via holes, each of the via holes penetrates through the female connection surface and the female fixing surface of the female bottom plate, the plurality of via holes are arranged in a grid in the female first direction and the female second direction, and the female second direction is perpendicular to the female first direction on the plane where the female fixing surface is disposed;
one or more ground terminal mounting slots are disposed on the female first side plate and/or the female second side plate, the ground terminal mounting slot extends from the female connection surface in a female third direction facing away from the female bottom plate;
the ground terminal mounting slot is provided with an electrical connection piece, the electrical connection piece comprises a protruding structure, a protruding side of the protruding structure faces away from a corresponding female first side plate or the female second side plate.

6. The female connector according to claim 5, wherein the female connector further comprises:
a female conductive surrounding frame, configured to be disposed between the female first side plate and the female second side plate and fixed to the female fixing surface, the female conductive surrounding frame is provided with a plurality of through slots, the plurality of through slots penetrate through the female conductive surrounding frame in a female third direction, and the female third direction is perpendicular to the plane where the female fixing surface is disposed;
one or more conductive terminal modules, configured to be inserted into one of the through slots, any one of the conductive terminal modules is provided with one or more female signal structures and one or more female grounding structures, any one of the female signal structures or any one of the female grounding structures is corresponded to one of the via holes, all of the female signal structures and the female grounding structures are arranged in a staggered manner one by one on the female connection surface of the female bottom plate, all of the female grounding structures are electrically connected with the female conductive surrounding frame and then connected to the ground;
the ground terminal mounting slot exposes the female conductive surrounding frame disposed at a corresponding position, and the electrical connection piece is provided.

7. The female connector according to claim 5, wherein the female connector further comprises:
one or more conductive reinforcement parts, configured to be disposed at a connection between the female bottom plate and the female first side plate and/or at a connection between the female bottom plate and the female second side plate, or disposed in the female first side plate and/or the female second side plate;
one or more conductive terminal modules, configured to be inserted into the via hole on the female base, any one of the conductive terminal modules is provided with one or more female signal structures and one or more female grounding structures, any one of the female signal structures or any one of the female grounding structures is configured to correspond to one of the via holes, all of the female signal structures and the female grounding structures are arranged in an one-to-one staggered manner on the female connection surface of the female bottom plate;
the conductive reinforcement part is electrically connected to the female grounding structure;
the ground terminal mounting slot exposes the conductive reinforcement part disposed at a corresponding position, and the electrical connection piece is provided.

8. The female connector according to claim 6, wherein any one of the ground terminal mounting slots is disposed near one of the female signal structures, and is arranged correspondently with the corresponding female signal structure in the female first direction;
the ground terminal mounting slot is provided with one or more channels, in case where there are two or more channels, the channels are arranged in parallel and locally connected, the ground terminal mounting slot is provided with the electrical connection piece.

9. A connector combination, the connector combination comprises a male connector and a female connector configured to be connected mutually, wherein the male connector comprises:
a male base, the male base is U-shaped from a side view, and the male base comprises a male bottom plate, a male first side plate and a male second side plate, the male bottom plate is provided with a male connection surface connected with the female connector, the male first side plate and the male second side plate are disposed at the two opposite sides of the male bottom plate in a male first direction respectively, and fixedly connected with the male bottom plate to surround the male connection surface, the male first direction is disposed at the plane where the male connection surface is disposed; a partial region of the male bottom plate is hollowed out, one or more male signal modules are disposed in the partial region, and the male signal module extends from the male connection surface in a direction facing away from the male bottom plate;
a male conductive surrounding frame, configured to be embedded in a hollowed-out region of the male bottom plate and substantially coplanar with the male bottom plate, one or more male grounding modules are disposed on the male conductive surrounding frame, the male grounding module extends from the male connection surface in a direction facing away from the male bottom plate, the male grounding module and the male signal module are arranged in a staggered manner one by one and shaped as a grid, and the male signal module is electrically connected with the male conductive surrounding frame and then connected to the ground;
one or more shielding reinforcement parts, configured to be disposed at a connection between the male bottom plate and the male first side plate and/or at a connection between the male bottom plate and the male second side plate, the shielding reinforcement part extends from the male connection surface in a direction facing away from the male bottom plate and is electrically connected with the male conductive surrounding frame;
the female connector comprises:
a female base, the female base is U-shaped from a side view, and the female base comprises a female bottom plate, a female first side plate and a female second side plate, the female bottom plate is provided with a female connection surface connected with the male connector and a female fixing surface opposite to the female connection surface, the female first side plate and the female second side plate are disposed at the two opposite sides of the female bottom plate in a female first direction respectively, and fixedly connected with the female bottom plate to surround the female connection surface, the female first direction is disposed at the plane where the female connection surface is disposed; the female bottom plate is provided with a plurality of via holes, each of the via holes penetrates through the female connection surface and the female fixing surface of the female bottom plate, the plurality of via holes are arranged in a grid in the female first direction and the female second direction, and the female second direction is perpendicular to the female first direction on the plane where the female fixing surface is disposed;
one or more ground terminal mounting slots are disposed on the female first side plate and/or the female second side plate, the ground terminal mounting slot extends from the female connection surface in a female third direction facing away from the female bottom plate;
the ground terminal mounting slot is provided with an electrical connection piece, the electrical connection piece comprises a protruding structure, a protruding side of the protruding structure faces away from the corresponding female first side plate or the female second side plate.

10. The connector combination according to claim 9, wherein the female connector further comprises:
a conductive surrounding frame, configured to be disposed between the female first side plate and the female second side plate and fixed to the female fixing surface, the female conductive surrounding frame is provided with a plurality of through slots, the plurality of through slots penetrate through the female conductive surrounding frame in a female third direction, and the female third direction is perpendicular to the plane where the female fixing surface is disposed;
one or more conductive terminal modules, configured to be inserted into one of the through slots, any one of the conductive terminal modules is provided with one or more female signal structures and one or more female grounding structures, any one of the female signal structures or any one of the female grounding structures is corresponded to one of the via holes, all of the female signal structures and the female grounding structures are arranged in a staggered manner one by one on the female connection surface of the female bottom plate, all of the female grounding structures are electrically connected with the female conductive surrounding frame and then connected to the ground;
the ground terminal mounting slot exposes the female conductive surrounding frame disposed at a corresponding position, and the electrical connection piece is provided;
the male connection surface of the male bottom plate and the female connection surface of the female bottom plate are connected face to face, each of the shielding reinforcement parts is separately inserted into one of the ground terminal mounting slots, and is connected to the corresponding electrical connection piece and/or the female conductive surrounding frame.

11. The connector combination according to claim 9, wherein the female connector further comprises:
one or more conductive reinforcement parts, configured to be disposed at a connection between the female bottom plate and the female first side plate and/or at a connection between the female bottom plate and the female second side plate, or disposed in the female first side plate and/or the female second side plate;
one or more conductive terminal modules, configured to be inserted into the via hole on the female base, any one of the conductive terminal modules is provided with one or more female signal structures and one or more female grounding structures, any one of the female signal structures or any one of the female grounding structures is corresponded to one of the via holes, all of the female signal structures and the female grounding structures are arranged in a staggered manner one by one on the female connection surface of the female bottom plate;
the conductive reinforcement part is electrically connected to the female grounding structure;
the ground terminal mounting slot exposes the conductive reinforcement part disposed at a corresponding position, and the electrical connection piece is provided;
the male connection surface of the male bottom plate and the female connection surface of the female bottom plate are connected face to face, each of the shielding reinforcement parts is separately inserted into one of the ground terminal mounting slots, and the shielding reinforcement part is connected to the corresponding female electrical connection piece and/or the conductive reinforcement part.

12. The connector combination according to claim 10, wherein any one of the shielding reinforcement parts is disposed near one of the male signal modules, and the shielding reinforcement part is disposed between the corresponding male signal module and the male first side plate or between the corresponding male signal module and the male second side plate in the male first direction;
any one of the ground terminal mounting slots is disposed near one of the female signal structures, and is arranged correspondently with the corresponding female signal structure in the female first direction;
the male first direction is the same as the female first direction;
the male connection surface of the male bottom plate and the female connection surface of the female bottom plate are connected face to face, and an outer side of each of the shielding reinforcement parts separately close to one of the ground terminal mounting slots is electrically connected with the electrical connection piece;
any one of the shielding reinforcement parts comprises one or more contact terminals, the contact terminals are arranged in a male second direction, and the male second direction is perpendicular to the male first direction on the plane where the male connection surface is disposed; a root end of each of the contact terminals is fixed to the male bottom plate, a free end of each of the contact terminals extends from the male connection surface in a direction facing away from the male bottom plate, and the contact terminal is configured to be bent or not bent according to a use environment, and the contact terminal is elastic during bending;
in case where the contact terminal is bent, the free end of the contact terminal comprises a first contact portion and a second contact portion, the first contact portion is electrically connected with the electrical connection piece, and the second contact portion is connected to the female conductive surrounding frame or the conductive reinforcement part;
any one of the shielding reinforcement parts at least comprises one or more metal contact terminals, the metal contact terminals are arranged in a male second direction, and the male second direction is perpendicular to the male first direction on the plane where the male connection surface is disposed; a root end of each of the metal contact terminals is fixed to the male bottom plate, a free end of each of the metal contact terminals extends from the male connection surface in a direction facing away from the male bottom plate;
the metal contact terminal is electrically connected with the electrical connection piece.

13. A connector combination, the connector combination comprises a male connector and a female connector configured to be connected mutually, wherein the male connector comprises:
a male base, the male base is U-shaped from a side view, and the male base comprises a male bottom plate, a male first side plate and a male second side plate, the male bottom plate is provided with a male connection surface connected with the female connector, the male first side plate and the male second side plate are disposed at the two opposite sides of the male bottom plate in a male first direction respectively, and fixedly connected with the male bottom plate to surround the male connection surface, the male first direction is disposed at the plane where the male connection surface is disposed; a partial region of the male bottom plate is hollowed out, one or more male signal modules are disposed in the partial region, and the male signal module extends from the male connection surface in a direction facing away from the male bottom plate;
a male conductive surrounding frame, configured to be embedded in a hollowed-out region of the male bottom plate and substantially coplanar with the male bottom plate, one or more male grounding modules are disposed on the male conductive surrounding frame, the male grounding module extends from the male connection surface in a direction facing away from the male bottom plate, the male grounding module and the male signal module are arranged in a staggered manner one by one and shaped as a grid with, and the male grounding module is electrically connected with the male conductive surrounding frame and then connected to the ground;
one or more shielding reinforcement parts, configured to be disposed at a connection between the male bottom plate and the male first side plate and/or at a connection between the male bottom plate and the male second side plate, the shielding reinforcement part extends from the male connection surface in a direction facing away from the male bottom plate and is electrically connected with the male conductive surrounding frame;
the female connector comprises:
a female base, the female base is U-shaped from a side view, and the female base comprises a female bottom plate, a female first side plate and a female second side plate, the female bottom plate is provided with a female connection surface connected with the male connector and a female fixing surface opposite to the female connection surface, the female first side plate and the female second side plate are disposed at the two opposite sides of the female bottom plate in a female first direction respectively, and fixedly connected with the female bottom plate to surround the female connection surface, the female first direction is disposed at the plane where the female connection surface is disposed; the female bottom plate is provided with a plurality of via holes, each of the via holes penetrates through the female connection surface and the female fixing surface of the female bottom plate, the plurality of via holes are arranged in a grid in the female first direction and the female second direction, and the female second direction is perpendicular to the female first direction on the plane where the female fixing surface is disposed;
one or more ground terminal mounting slots are disposed on the female first side plate and/or the female second side plate, the ground terminal mounting slot extends from the female connection surface in a female third direction facing away from the female bottom plate, a protruding side of the protruding structure faces away from the corresponding female first side plate or the female second side plate, the protruding structure is connected to the shielding reinforcement part.

14. The connector combination according to claim 13, wherein the female connector further comprises:
a conductive surrounding frame, configured to be disposed between the female first side plate and the female second side plate and fixed to the female fixing surface, the female conductive surrounding frame is provided with a plurality of through slots, the plurality of through slots penetrate through the female conductive surrounding frame in a female third direction, and the female third direction is perpendicular to the plane where the female fixing surface is disposed;
one or more conductive terminal modules, configured to be inserted into one of the through slots, any one of the conductive terminal modules is provided with one or more female signal structures and one or more female grounding structures, any one of the female signal structures or any one of the female grounding structures is corresponded to one of the via holes, all of the female signal structures and the female grounding structures are arranged in a staggered manner one by one on the female connection surface of the female bottom plate, all of the female grounding structures are electrically connected with the female conductive surrounding frame and then connected to the ground;
the ground terminal mounting slot exposes the female conductive surrounding frame disposed at corresponding position, and the electrical connection piece is provided;
each of the shielding reinforcement part is seperately connected to the corresponding female electrical connection piece and/or to the corresponding conductive surrounding frame.

15. The connector combination according to claim 13, wherein the female connector further comprises:
one or more conductive reinforcement parts, configured to be disposed at a connection between the female bottom plate and the female first side plate and/or at a connection between the female bottom plate and the female second side plate, or disposed in the female first side plate and/or the female second side plate;
one or more conductive terminal modules, configured to be inserted into the via hole on the female base, any one of the conductive terminal modules is provided with one or more female signal structures and one or more female grounding structures, any one of the female signal structures or any one of the female grounding structures is corresponded to one of the via holes, all of the female signal structures and the female grounding structures are arranged in a staggered manner one by one on the female connection surface of the female bottom plate;
the conductive reinforcement part is electrically connected to the female grounding structure;
the ground terminal mounting slot exposes the conductive reinforcement part disposed at a corresponding position, and the electrical connection piece is provided;
each of the shielding reinforcement part is separately connected to the corresponding electrical connection piece and/or to the corresponding conductive reinforcement part.
